(19) United States
(12) Patent Application Publication
(10) Pub. No.: US 2016/0146239 A1
(43) Pub. Date: May 26, 2016

(54) Security Lock Bolt Assembly

(71) Applicant: NIC Products Inc., Walnut Creek, CA (US)

(72) Inventor: Ian A. NAZZARI, Moraga, CA (US)

(21) Appl. No.: 14/947,190

(22) Filed: Nov. 20, 2015

Related U.S. Application Data
(60) Provisional application No. 62/082,702, filed on Nov. 21, 2014.

(51) Int. Cl. F16B 21/08; E05B 65/00; E05B 39/00; E05B 63/00

(52) U.S. Cl. CPC F16B 21/08; E05B 63/00; E05B 65/00; E05B 39/00; E05B 2063/0026

(57) ABSTRACT

A lock bolt assembly includes a bolt body comprising metal and having a proximal end area, a distal end area, and a circumferential locking groove. A locking cylinder comprises metal and has an inner cylinder bore including a cylinder locking feature. The cylinder locking feature and the locking groove are arranged to be irreversibly coupled to each other when the bolt body is fully received in the inner cylinder bore. A transparent cap member is connected to the locking cylinder that includes an axial bore. The cap member defines a locking abutment in the axial bore and a keyway substantially vertically aligned with the locking abutment. A bolt body casing is permanently attached to the bolt body and defines a key element situated in the keyway and a locking finger engaging the locking abutment in an irreversible manner when the locking groove is irreversibly coupled to the cylinder locking feature.

### FIELD OF ART

The disclosure relates to the field of security seals, and more particularly to a lock bolt security seal assembly.

### BACKGROUND

Lock bolts are used to secure or seal objects against unauthorized access much in the manner of padlocks and the like, but are specifically intended to reveal tampering with the seal by visual inspection. Thus, lock bolts are typically arranged so that a visual inspection will show that the seal is secure and had not been tampered with in an unauthorized manner from the time it is installed up to the time it is released from the sealed object.

Typical known lock bolts include a lock bolt body and a locking cylinder irreversibly connected together by a locking feature that enables quick and simple assembly of the bolt body to the locking cylinder but prevents later separation of the two elements without breaking all or part of the lock bolt assembly, which breakage will be readily apparent by visual inspection.

The prior art lock bolts, while functioning in a manner that provides a locked seal, lack the ability to provide a clearly visible indication of a fully locked condition of a primary internal lock feature between a lock bolt element and a cooperating locking cylinder element, and lack a secondary locking feature that provides a second lock in addition to the primary internal lock between a lock bolt element and a locking cylinder element, while providing a visible indication of a locked condition of the lock bolt and any evidence of tampering with the lock bolt that has interfered with its locked condition.

In view of the shortcomings of conventional lock bolt seals, there exists a substantial need tor a lock bolt seal that is considerably improved in terms of assuring the lock bolt is completely secure and providing a secondary locking mechanism if the primary locking mechanism is compromised.

### BRIEF SUMMARY

A lock bolt assembly in accordance with the disclosure is useable for sealing an object such as a container, vehicle body, meter, access door, etc. against unauthorized access includes an elongate bolt body having an irreversible locking feature such as a circumferential locking groove located at a position along its length and that is receivable in a bore in a cooperating locking cylinder that includes an irreversible locking feature within the bore, such as a split spring locking ring, adapted to cooperate with the irreversible locking feature on the bolt body when the bolt body is fully received within the locking cylinder bore.

The bolt body is configured to be received within the bore in a manner such that the locking features of the bolt body and the locking cylinder will be coupled and locked together in an irreversible manner once assembled together, and any attempt to separate the bolt body from the locking cylinder will require breaking the bolt body, the locking feature and/or the locking cylinder. Thus, the bolt lock is configured to provide a visible indication of surreptitious interference with its locking and sealing function.

The bolt body of the present disclosure is provided with both a first or primary internal locking feature irreversibly locking the bolt body to the locking cylinder when the bolt body is in the secured assembled configuration, as well as a secondary locking feature locking the bolt body to the locking cylinder in a manner that is visible to an outside viewer through a transparent. cap member.

The transparent cap member provides part of the secondary locking feature in the form of a locking abutment that cooperates with a locking finger provided on the bolt body. The transparent cap member is securely locked permanently to the locking cylinder in an embodiment. Accordingly, the bolt body is secured irreversibly to the locking cylinder when they are assembled in a secured configuration with the bolt body received in the bore of the locking cylinder by two locks, namely a first internal locking feature within the bore of the locking cylinder, and a second bolt body locking feature in the form of a locking finger on the bolt body that engages the visible locking abutment within the transparent cap member covering the upper end of the locking cylinder.

According to a variation, the bolt body includes a casing having an outer diameter substantially corresponding to a diameter of the axial bore in the cap member such that when the bolt body is inserted into the locking cylinder the bolt body casing seals or closes the axial bore of the cap member to thereby prevent tampering with the locking finger.

According to a variation, the bolt body casing defines a key element and the axial opening of the cap member defines a keyway arranged to receive the key element when the bolt body is fully inserted into the locking cylinder. When the key element is received in the keyway, the bolt body is not able to rotate relative to the cap member, which, in turn, prevents the locking finger from being broken or damaged due to twisting or rotation of the bolt body within the locking cylinder. The keyway can be generally vertically aligned with the locking abutment and the key element can be generally vertically aligned with the locking finger, ensuring that the locking finger is properly aligned with the locking abutment when the bolt body is inserted into the locking cylinder. This facilitates handling and installation.

### BRIEF DESCRIPTION OF THE DRAWINGS

Reference is made to the appended drawings depicting illustrative embodiments of the inventive subject matter to be described in more detail below, wherein:

FIG. 1 is an exploded view of a security lock bolt assembly according to an embodiment.

FIG. 2 is a cross section view of the security lock bolt shown in FIG. 1 showing the internal structures of the elements.

FIG. 3 is a bottom view of the bolt body shown in FIG. 1.

FIG. 4 is a partial cross section view of the internal structure of the part of the lock bolt assembly and the locking cylinder elements in a locked configuration.

FIG. 5 is a top view of the locking cylinder shown in FIG. 1.

FIG. 6 is a perspective front view of the lock bolt in the locked configuration,

FIG. 7 is an exploded view of a security lock bolt assembly according to another embodiment.

FIG. 8 is a bottom view of the bolt body shown in FIG. 7.

FIG. 9 is a top view of the locking cylinder shown in FIG. 7.

FIG. 10 is a perspective front view of the lock bolt assembly in a lock configuration,

### DETAILED DESCRIPTION OF VARIOUS EMBODIMENTS

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. It should be understood, however, there is no intention to limit the disclosure to the specific embodiments disclosed, but on the contrary, the intention covers all modifications, alternative constructions, combinations, and equivalents falling within the spirit and scope of the disclosure.

It will be understood that unless a term is expressly defined in this patent to possess a described meaning, there is no intent to limit the meaning of such term, either expressly or indirectly, beyond its plain or ordinary meaning.

Any element in a claim that does not explicitly state “means for”, performing a specified function, or “step for”, performing a specific function, is not to be interpreted as a “means” or “step” clause as specified in 35 U.S.C. §112, paragraph 6.

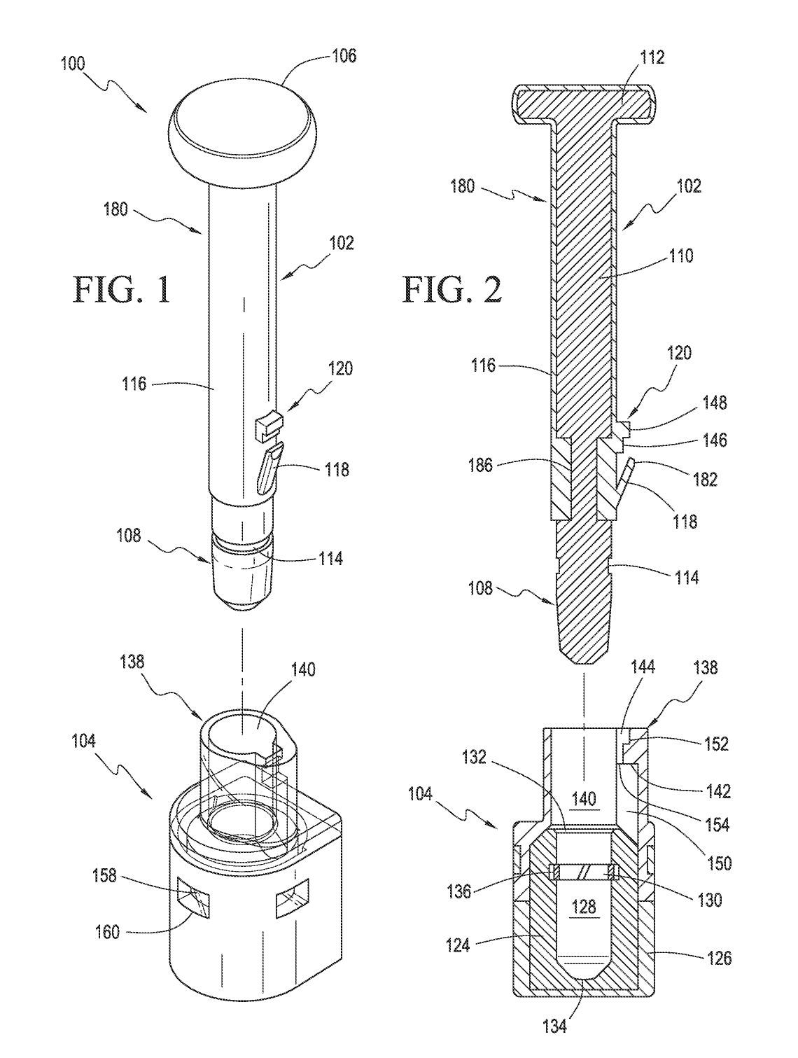

With reference to FIGS. 1-6, an exemplary embodiment of a security lock bolt assembly 100 including an elongate axially extending bolt body 102 having a desired length and a locking cylinder 104. The bolt body 102 is arranged to cooperate with the locking cylinder 104 to provide a security seal for an object to be locked against intrusion or opening in a manner that will reveal any attempt at such intrusion or opening.

Specifically, the bolt body 102 includes a distal end area that becomes irreversibly locked with the locking cylinder 104 by first and/or second locking features when the bolt body 102 is inserted into the cylinder during a sealing procedure wherein the bolt body 102 is inserted through an opening or structure for receiving the bolt body in an object (e.g., container, vehicle body, meter, access door, etc.) to lock the object against opening or displacement and is locked within the locking cylinder so that the bolt body cannot be removed or separated from the locking cylinder without fracturing one or more of the bolt body, the locking cylinder, and the locking element.

Thus, the object to be sealed in a secure manner cannot be opened or moved in a manner that will escape detection of overt or surreptitious entry or movement involving damaging or destroying the lock bolt. In accordance with usual practice, when it is desired to release the lock bolt by an appropriate party, the bolt body is cut with an appropriate tool (e.g., a bolt cutter) to release the lock bolt from the object and to enable access to the object that was locked or sealed. Accordingly, the lock bolts of this kind are usually intended for single use only.

The bolt body 102 can be initially formed separate from the locking cylinder 104 as shown in FIG. 1. The bolt body 102 can be made from steel or any other material that cannot be readily fractured, deformed or broken during use in a manner that would interfere with its sealing function. The bolt body 102 can include an enlarged head 106 at its proximal end area 180 and a tapered distal end area 108 that is arranged to be locked within the locking cylinder 104.

As seen in FIG. 2, the bolt body 102 includes an internal metal shank 110 and an internal metal head 112 that defines the enlarged head 106. The distal end area 108 is an extension of the shank 110 and includes a circumferential locking groove 114 formed about the circumference of the shank 110, the purpose and function of which will be described below. The bolt body 102 can be formed in a circular cross section shape, but this is optional, whereby the cross section may be in any desired form compatible with the intended use of the lock bolt.

The proximal end area 180 of the bolt body 102 can include an over-molded casing 116. The bolt body casing 116 can be formed of a relatively hard resinous or plastic material over the internal head 112 and over at least a portion of the shank 110. The bolt body casing 116 can include a generally constant outer diameter below the enlarged head 106 outside the areas of the locking finger and locking element described below. Optionally, the shank 110 defines a circumferential groove or recessed portion 186 filled with a portion of the bolt body casing 116 to create a mechanical lock between the bolt body casing 116 and the shank 110. This can help secure the bolt body casing 116 to the shank 110. The groove 186 can have a rectangular or any other suitable cross section shape.

The bolt body casing 116 can define at least one locking finger 118 attached in cantilever fashion to the bolt body casing 116, which is bendable radially inwardly toward the shank 110 when pressed inwardly as described below, The locking finger 118 can be integral to the bolt body casing 116. The bolt body casing 116 can be opaque or transparent.

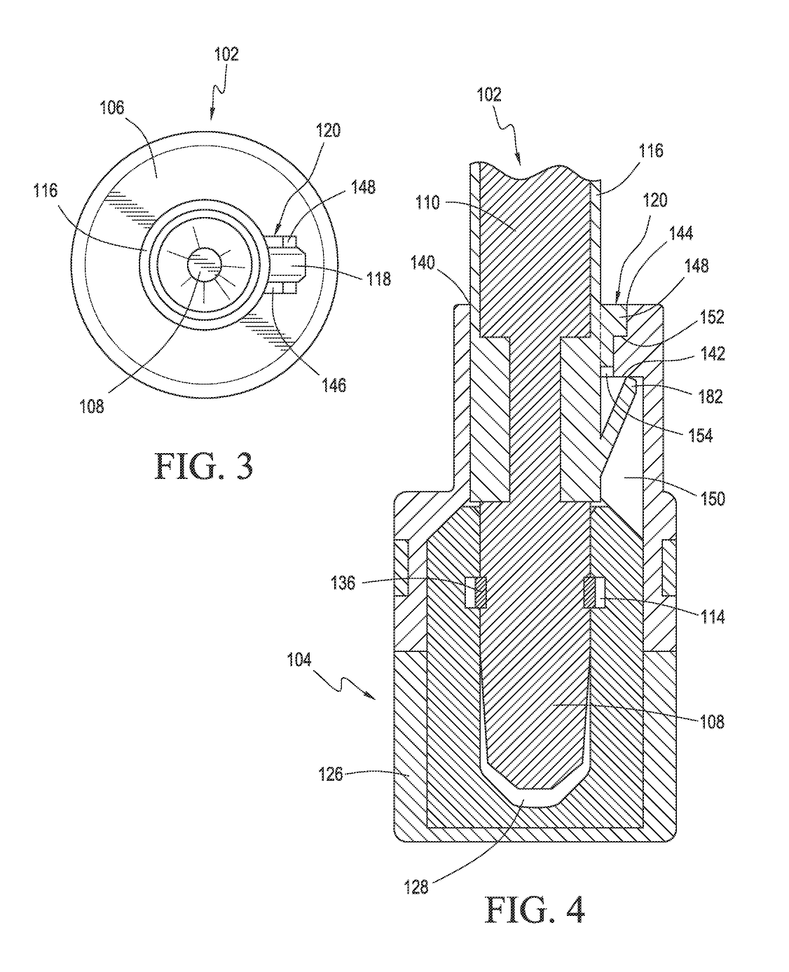

As best shown in FIGS. 2 and 3, a key element 120 is also defined by the bolt body casing 116. The key element 120 can exhibit any suitable arrangement but is shown including a lower portion 146 having an upright configuration and an upper portion 148 having a generally horizontal configuration extending radially outward beyond the lower portion 146. The key element 120 can include substantially planar sides that are substantially parallel to one another. The key element 120 can comprise a portion of the bolt body casing 116. When the locking finger 118 is pressed inwardly, a flee end portion 182 of the locking finger 118 can move below the lower portion 146 of the key element 120. The purpose and function of the key element 120 will be evident from the description to follow.

Referring again to FIG. 2, the locking cylinder 104 includes an inner cylinder 124 arranged to receive a distal end area 108 of the shank 110, including the locking groove 114. The inner cylinder 124 can be formed from a high strength metal or other suitable material.

An over-molded casing 126 can be provided over the inner cylinder 124, and can be secured against separation from the inner cylinder 124. One or more portions of the over-molded casing 126 can be made of the same material as the bolt body casing 116 of the bolt body. One or more portions of the over-molded casing 126 can be formed of a transparent rigid resinous (plastic) material. The outer contour or profile of the over-molded casing 126 can include a planar rear side and a generally arcuate front side, although the outer shape of the locking cylinder may be selected on the basis of aesthetics or functionality depending on the desired or intended use of the security lock bolt.

The inner cylinder 124 can include an inner cylinder bore 128 that defines an undercut circumferential groove or recess 130 between the open end 132 of the inner cylinder bore and a closed bottom 134 of the inner cylinder bore. A split locking ring 136 can be situated in the groove 130. The inner diameter of the locking ring 136 when it is in its relaxed state can be smaller than the inner diameter of the inner cylinder bore 128 and also smaller than the outer diameter of the shank 110 of the bolt body 102.

The groove 130 is dimensioned so that the locking ring 136 can expand radially outwardly while the locking ring 136 is captured within the groove 130 so that its inner diameter will be about the same as the inner diameter of the inner cylinder bore 1128.

As shown in FIG. 4, when the bolt body 102 is to be assembled to the locking cylinder 104, the tapered distal end area 108 of the shank 110 may be received within the inner cylinder bore 128 until the tapered distal end area 108 engages the locking ring 136, at which point continued insertion of the distal end area 108 into the inner cylinder bore 128 urges the locking ring 136 into a radially expanded configuration to enable the shank 110 to continue to be inserted within the inner cylinder bore 128 until the circumferential locking groove 114 reaches a position opposite the locking ring 136.

At this point, the locking ring 136 will snap by spring action into a contracted configuration towards its relaxed state so that its inner diameter is now smatter than the outer diameter of the shank 110 on either side of the locking groove 114, so that the shank 110 is now captured irreversibly within the locking cylinder 104 by the locking ring 136.

As best shown in FIGS. 2 and 4, the locking cylinder 104 can include a transparent cap member 138 having an axial bore 140 generally aligned with the inner cylinder bore 128. The axial bore 140 can have a generally constant inner diameter along its length outside of the areas of the keyway, locking abutment, and receiving space described below. The axial bore 140 can be dimensioned and configured such that when the bolt body 102 is inserted into the locking cylinder 104, the bolt body casing 116 of the bolt body 102 effectively closes or seals the axial bore 140. For instance, an outer diameter of the bolt body casing 116 can substantially correspond to the inner diameter of the axial bore 140 such that when the shank 110 is inserted into the inner cylinder bore 128, the bolt body casing 116 forms a seal between the bolt body 102 and the locking cylinder 104 to thereby prevent tampering with the locking finger 118 when the shank 110 is inserted fully into the cylinder bore 128 and locked therein in a manner that will be evident in the description to follow. This allows the lock bolt assembly 100 to be seated without the use of radial cover elements or flat-bottomed holes formed in the axial bore 140, making the lock bolt assembly 100 easier and less expensive to manufacture.

The cap member 138 can be formed from of a transparent rigid resinous (plastic) material having suitable strength characteristics to cooperate with the locking finger 118 and the key element 120 when lock bolt is fully assembled.

The cap member 138 can define a cap locking feature comprising a locking abutment 142 defined in a side of the axial bore 140. The axial bore 140 can define a receiving space 150 below the locking abutment 142 for accommodating the locking finger 118, and a stop surface that cooperates with the free end portion 182 of the locking finger 118 when the shank 110 of the bolt body 102 is inserted into the inner cylinder bore 128. The stop surface can be a generally horizontally extending stop surface that cooperates with the free end portion 182 of the locking finger 118.

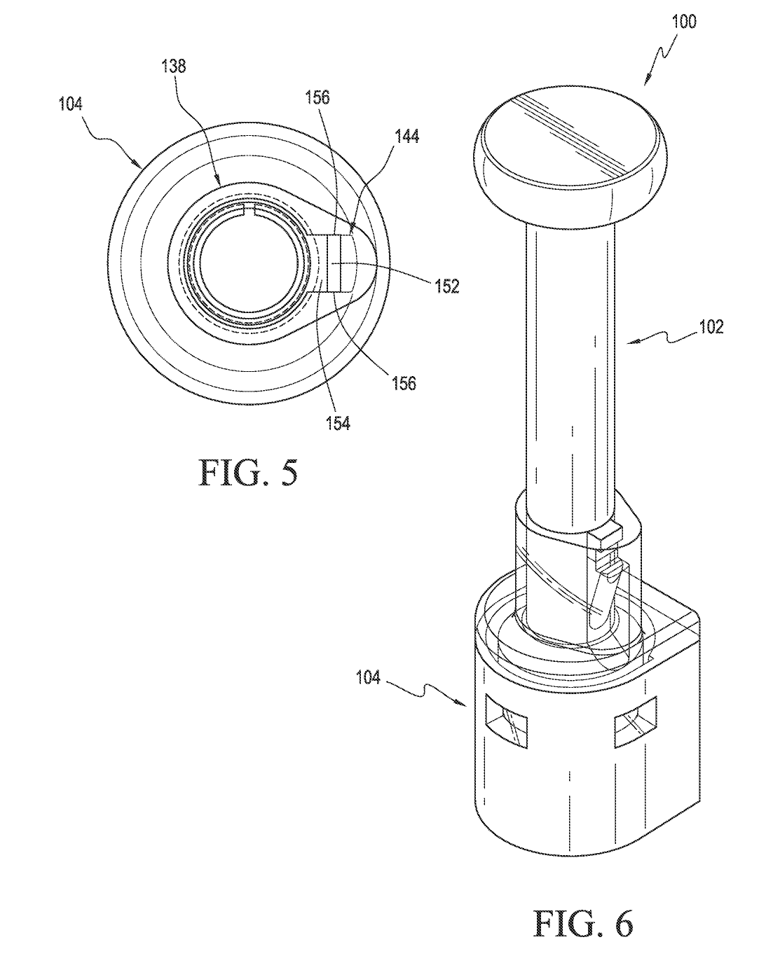

The cap member 138 can define a keyway 144 above the locking abutment 142. The keyway 144 can be substantially vertically aligned with the locking abutment 142. More particularly, the keyway 144 can include a center substantially vertically aligned with a center of the locking abutment 142. The keyway 144 is arranged to receive the key element 120 of the bolt body 102 when the shank 110 is fully inserted into the inner cylinder bore 128. The keyway 144 can be sized and configured to generally correspond to the key element 120. For instance, the keyway 144 defines parallel sidewalk 156 (shown in FIG. 5) separated by a stop surface 152 that cooperates with a bottom surface of the upper portion 148 of the key element 120. The stop surface 152 can be a generally horizontally extending stop surface that will cooperate with the bottom surface of the upper portion 148 of the key element 120.

A passageway 154 can be formed in the axial bore 140 that allows the locking finger 118 to slide past or through the keyway 144 and into engagement with the locking abutment 142 during installation of the bolt body 102 into the locking cylinder 104. The passageway 154 can be defined at least in part by the keyway 144.

When the bolt body casing 116 is inserted into the axial bore 140, the locking finger 118 can advance through the passageway 154 as it is increasingly pressed inwardly by the keyway 144 until its free end portion 182 is forced below the lower portion 146 of the key element 120. The passageway 154 thus can provide the only structure through which the locking finger 118 can access the locking abutment 142. The passageway 154 also can receive at least some of the lower portion 146 of the key element 120 when the shank 110 of the bolt body 102 is inserted fully into the inner cylinder bore 128.

The interaction between the key element 120 and the keyway 144 prevents or limits rotation of the bolt body 102 relative to the locking cylinder 104 when the bolt body 102 is fully inserted into the locking cylinder 104. More particularly, because the key element 120 is received and retained between the sides of the keyway 144, the bolt body 102 is not able to rotate relative to the cap member 138, which, in turn, prevents rotation of the bolt body 102 relative to the locking cylinder 104 when the shank 110 is fully inserted into the inner cylinder bore 128. This advantageously helps prevent the locking finger 118 from being broken or damaged due to twisting or rotation of the bolt body 102 within the locking cylinder 104.

The interaction between the key element 120 and the keyway 144 also provides an index to help ensure that the locking finger 118 is aligned with the locking abutment 142 when the bolt body 102 is inserted into the locking cylinder 104. For instance, the keyway 144 is formed on the cap member 138 so that the locking finger 118 on the bolt body 102 will only tit one way into the cap member 138. In an embodiment, the keyway 144 can be generally aligned with the locking abutment 142 and the key element 120 can be generally aligned with the locking finger 118. This facilitates handling and installation, and ensures that the locking finger 118 locks into the locking abutment 142 when the shank 110 is fully inserted into the inner cylinder body 128. While only one key and one keyway are illustrated, this is exemplary only, and more than one key and respective cooperating keyway could be provided in accordance with the disclosure.

The cap member 138 can be connected to the over-molded casing 126 of the locking cylinder 104 by at least one radial projection 158 (shown in FIG. 1) that closely fits within at least one cooperating radial opening 160 (shown in FIG. 1) in the over-molded casing 126, with each projection 158 and the adjacent body of the cap member 138 disposed between an outer wall of the inner cylinder 124 and the adjacent over-molded casing 126. In an embodiment, three projections 158 are located within a corresponding plurality of openings 160. Thus, once formed, the cap member 138 is tightly held onto the locking cylinder 104 and cannot be separated from the locking cylinder without breaking the cap member 138 or the over-molded casing 126, or both, which would reveal tampering with the lock bolt. The cap member 138 may be formed by injection molding the cap member to the over-molded casing 126 of the locking cylinder 104 with the projections 158 molded directly into the openings 160.

The openings 160 may be through holes as shown, or internal depressions or sockets (not shown) that can receive the projection or projections 158. When the through holes are provided as openings 160 they have the advantage of enabling visible inspection of the projections 158 and the presence of the metal inner cylinder 124.

In use, the bolt body 102 is manipulated to cooperate with an object to be sealed (not shown), typically a hasp or other element associated with the object to be sealed, such as a closure, door, cover, etc. by placement of the bolt body 102 through an opening of the hasp or element of the object to be sealed. The key element 120 formed on the bolt body 102 is then aligned with the keyway 144 defined by the cap member 138 and the distal end area 108 of the bolt body 102 is inserted through the cap member 138 and into the locking cylinder 104 until the circumferential locking groove 114 is opposite the split locking ring 136, which as described above, has been slightly opened in elastic fashion during passage of the tapered distal end area 108 through the locking ring 136.

The locking ring 136 will then snap back into a normal smaller diameter form when the locking groove 114 is located opposite the locking ring 136 to engage the locking groove 114. Thus, the shank 110 becomes irreversibly locked against withdrawal from the inner cylinder bore 128 by the locking ring 136 when the locking ring 136 and locking groove 114 are engaged together.

When the locking ring 136 and locking groove 114 are engaged together, the position of the lock bolt body 102 relative to the locking cylinder 104 is such that the locking finger 118 will become lodged beneath the locking abutment 142.

The normal relaxed position of the locking finger 118 is such that the free end portion 182 of the locking finger 118 extends wider than or radially beyond the diameter of the axial bore 140 of the cap member 138, so that insertion of the bolt body casing 116 and the locking finger 118 through the axial bore 140 until the locking ring 136 engages the locking groove 114 requires the locking finger 118 to be resiliently and elastically bent radially inwardly toward the central axis of the bolt body 102 as it passes through the keyway 144 and the passageway 154 within the axial bore 140. In an embodiment, as the distal end area 108 of the bolt body 102 is advanced through the locking cylinder 104, the keyway 144 on the cap member 138 resiliently and elastically bends the locking finger 118 radially inwardly as the locking finger 118 moves through the passageway 154.

The locking abutment 142 is configured and dimensioned to be positioned so that the free end portion 182 of the locking finger 118 will snap back radially outwardly relative to the axis of the bolt body 102 just when it passes the locking abutment 142 as the bolt body 102 moves into the locking cylinder 104 towards a fully inserted position when the locking ring 136 engages the locking groove 114.

At this position, the locking finger 118 likewise engages the locking abutment 142 of the cap member 138 in an irreversible manner to provide a secondary locking together of the bolt body 102 and the locking cylinder 104. The axial bore 140 and keyway 144 are arranged so that the locking finger 118 can only enter the axial bore 140 through the keyway 144 vertically aligned or located above the locking abutment 142, This has the advantage of providing an index to ensure that the locking finger 118 is aligned with the locking abutment 142.

In addition, the outer diameter of the bolt body casing 116 of the bolt body 102 closely fits the inner diameter of the axial bore 140 to effectively close and/or seal the axial bore 140 of the cap member. This beneficially prevents tampering with the locking finger 118 when the locking finger 118 is locked in the locking abutment 142.

The distal end area 108 of the bolt body 102 in the fully inserted position will be located at or closely adjacent the cylinder bottom end 134. The shank 110 and inner cylinder bore 128 are dimensioned so that the terminal end of the metal shank will extend approximately to the bottom of the inner cylinder bore 128 when the metal shank is locked within the inner cylinder bore 128 by the primary locking feature, namely the locking ring 136 and the locking groove 114. While the shank 110 is illustrated as extending up to the bottom of the inner cylinder bore 128, it will be understood that in practice a clearance may be desired between the shank 110 and the bottom of the inner cylinder bore 128 to ensure that the locking ring 136 will be fully engaged with the locking groove 114 of the metal shank 110 despite manufacturing tolerances that could result in slight variations in the dimensions of the shank 110, inner cylinder bore 128 and the other locking elements of the lock bolt.

With the bolt body 102 fully inserted into the locking cylinder 104, the secondary locking feature embodied in this example by the locking finger 118 engaging the locking abutment 142 of the cap member 138 will be openly visible for remote inspection and due to the geometry of the spacing between the free end of the locking finger 118 and the locking groove 114, on the one hand, and the relative position of the locking abutment 142 relative to the locking cylinder 104, on the other hand, the position of the locking finger 118 relative to the locking abutment 142 will provide a visible indication that the locking ring 136 is tidily engaged with the locking groove 114.

Furthermore, relative rotation between the bolt body 102 and the locking cylinder 104 is prevented by the key element 120 received within the keyway 144. This advantageously prevents the locking finger 118 from being broken or damaged due to twisting or rotating of the bolt body 102 within the inner cylinder bore 128.

Moreover, if for any reason (such as malicious tampering with the lock bolt before assembly) the locking ring 136 has been removed from the inner cylinder 124 during assembly, the secondary locking feature provided by the locking finger 118 engaged with the locking abutment 142 will ensure that the bolt body 102 is retained in the locking cylinder 104 and a visible inspection of such secondary locking feature will be provided by the cap member 138 which enables remote viewing of the position of the locking finger 118 relative to the locking abutment 142.

Any tampering with the lock bolt assembly when fully locked together in an attempt to separate the bolt body 102 from the locking cylinder 104 will be evident due to the cap member 138 which will reveal at least tampering with the locking finger 118. The filly assembled and locked lock bolt assembly 100 is shown in FIG. 6.

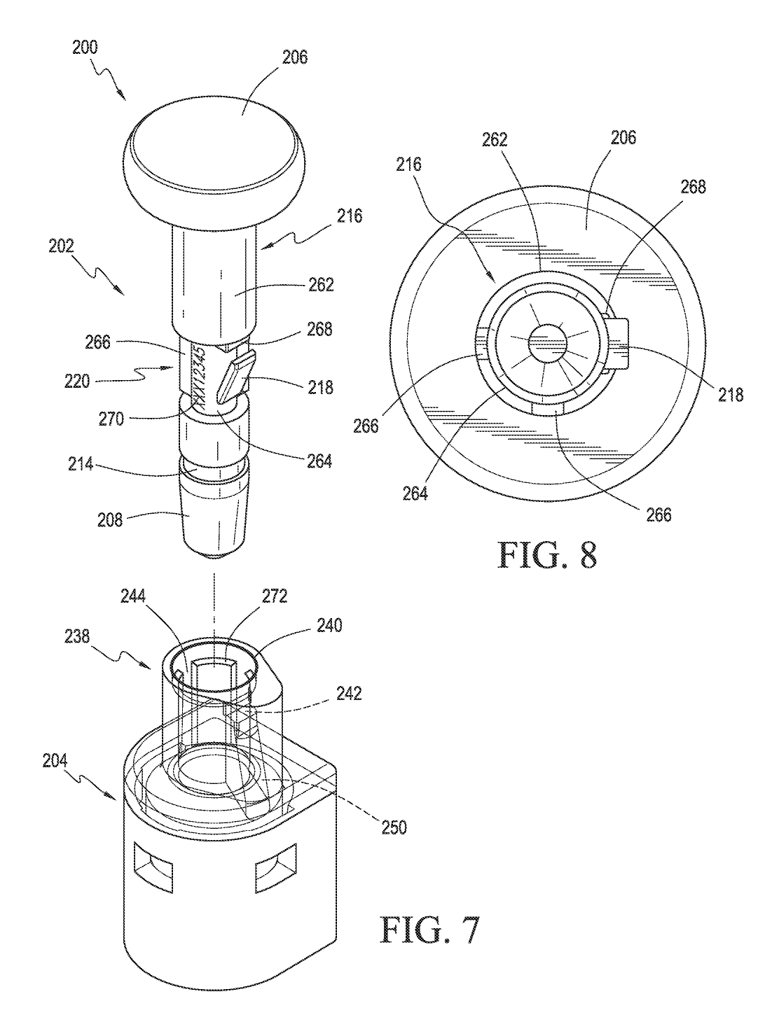

FIGS. 7-10 illustrate a security lock bolt assembly 200 according to another embodiment. The security lock bolt assembly 200 can be similar to the lock bolt assembly 100 including a bolt body 202 and a locking cylinder 204 as seen in FIG. 7. In the illustrated embodiment, the locking cylinder 204 and the locking cylinder 104 have the same components and features. Therefore, in the interest of brevity, an explanation of the components and features of the locking cylinder 204 will not repeated.

The bolt body 202 can be made from steel or any other material that cannot be readily fractured, deformed or broken during use in a manner that would interfere with its sealing function. The bolt body 202 can include an enlarged head 206 at its proximal end area and a tapered distal end area 208 that is arranged to be locked within the locking cylinder 204. The bolt body 202 includes an internal metal shank and an internal metal head that defines the enlarged head 206.

The distal end area 208 is an extension of the metal shank and includes a circumferential locking groove 214 formed about the circumference of the shank. The bolt body 202 can be formed in any suitable cross section shape. The bolt body 202 can have an overall shorter length than the bolt body 102. It will be appreciated that the length of the bolt body 202 can be varied based on a specific application or object being sealed.

Similar to the bolt body 102, the bolt body 202 includes an over-molded casing 216 that can be formed of a relatively hard resinous or plastic material over a metal head and at least a portion of an internal metal shank. The over-molded casing 216 can include a first portion 262 having an outer diameter and extending downward from the enlarged head 206. The outer diameter of the first portion 262 can be generally constant. The outer diameter of the first portion 262 can be greater than an outer diameter of the distal end area 208 of the bolt body 202.

A second portion 264 of the over-molded casing 216 can extend between the first portion 262 and a top surface of the distal end area 208 of the metal shank. As seen in FIG. 8, the second portion 264 can have an outer diameter smaller than the outer diameter of the first portion 262 and can be substantially concentric with the first portion 262.

The second portion 264 of the over-molded casing 216 can define at least one locking finger 218 attached in a cantilever fashion to the second portion 264 at or near the top edge of the distal end area 208. The locking finger 218 is bendable radially inwardly toward the second portion 264 when pressed inwardly. It will be appreciated that the locking finger 218 can be integral to the over-molded casing 216. The over-molded casing 216 can be opaque or transparent.

The second portion 264 of the over-molded casing 216 can also define a plurality of key elements 220. In an embodiment, the key elements 220 include a pair of key elements 266 spaced about 90 degrees from one another on the second portion 264. Each of the key elements 266 can extend in a longitudinal direction between the first portion 262 and the top surface of the distal end area 208. The radial outer surface of the key elements 266 can generally correspond to the outer surface of the first portion 262. The radial outer surface of the key elements 266 can also extend radially outward from the outer surface of the distal end area 208.

The key elements 266 can have any suitable cross section but are shown having a rectangular cross section. The key elements 220 can also define a shorter key element 268 extending from the first portion 262 above the locking finger 218. The key element 268 can have a width greater than a width of the locking finger 218.

Optionally, the bolt body 202 can include a tracking unit 270 including security or other information associated with the lock bolt assembly and/or the object to be sealed. As shown, the tracking unit 270 can be located on the second portion 264 of the over-molded casing 216. It will be appreciated that the tracking unit 270 can be located at any suitable location on the lock bolt assembly 200 and in any form. The tracking unit 270 can be an encrypted code/identifier. in an embodiment, the tracking unit 270 can link and/or integrate the lock bolt assembly embodiments and/or the sealed object with an inventory or asset management system, such as any of the systems disclosed in U.S. patent application Ser. No. 14/932,844, the disclosure of which is incorporated herein by this reference in its entirety.

A transparent cap member 238 can be connected to the locking cylinder 204 and can include an axial bore 240 generally aligned with the inner cylinder bore. The cap member 238 can include a top recess 272 that is intended to receive the bottom of the first portion 262 of the over-molded casing 216 when the bolt body 202 is fully inserted into the locking cylinder 204, The first portion 262 is sized and configured such that is effectively closes the axial bore 240 when the bolt body 202 is fully inserted into the locking cylinder 204 to thereby prevent tampering with the locking finger 218.

The cap member 238 can define a cap locking feature comprising a locking abutment 242 defined in a side of the axial bore 240. A receiving space 250 can be formed below the locking abutment 242 for accommodating the locking finger 218. The locking abutment 242 defines a stop surface that cooperates with a free end of the locking finger 218 when the bolt body 202 is inserted fully into the locking cylinder 204. The stop surface can be a generally horizontally extending stop surface that cooperates with the free end portion of the locking finger 218.

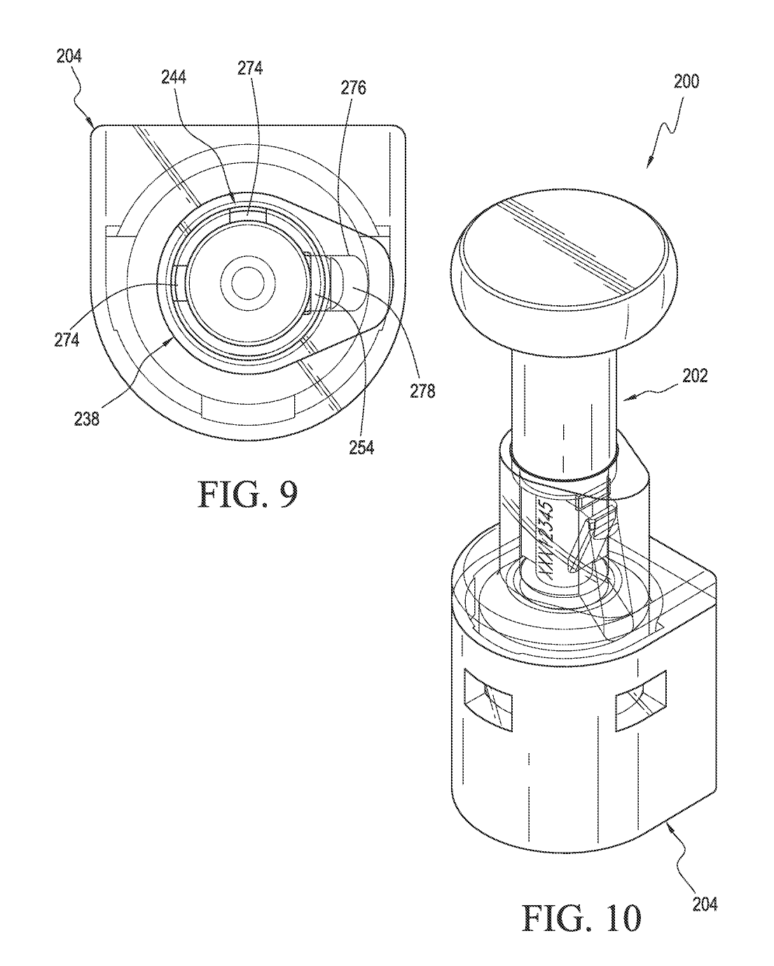

The cap member 238 defines a plurality of keyways 244 generally corresponding to the key elements 220 of the bolt body 202. As seen in FIG. 9, the keyways 244 can include a pair of elongate keyways 274 comprising slots generally corresponding to the key elements 266 and a shorter keyway 276 generally corresponding to the key element 268. The elongate configuration of the keyways 274 and the key elements 266 increases the surface contact area between them, which, in turn, increases the resistance of the lock bolt assembly 200 to relative rotation between the bolt body 202 and the locking cylinder 204.

The keyway 276 is located above the locking abutment 242 and defines a stop surface 278 that cooperates with a portion of the bottom surface of the key element 268.

In the illustrated embodiment, the keyway 276 has a width greater than the locking abutment 242. A passageway 254 defined in a bottom of the keyway 276 connects the keyway 276 and the locking abutment 242. This allows the locking finger 218 to pass through the keyway 276 and into the locking abutment 242.

The keyways 244 are arranged to receive the key elements 220 of the bolt body 202 when the bolt body 202 is fully inserted into the locking cylinder 204. This prevents or limits rotation of the bolt body 202 relative to the locking cylinder 204 when the bolt body 202 is fully inserted into the locking cylinder 204, which, in turn, prevents the locking finger 218 from being broken or damaged due to twisting or rotating the bolt body 202 within the locking cylinder 204. The interaction between the key elements 220 and the keyways 244 also provides an index to ensure that the locking finger 218 is aligned with the locking abutment 242 when the bolt body 202 is inserted into the locking cylinder 204, facilitating assembly and installation.

In use, the bolt body 202 is manipulated to cooperate with an object to be sealed and the key elements 220 formed on the bolt body casing 216 are aligned with the keyways 244 defined in the axial bore of the cap member 238. The distal end area 208 of the bolt body 202 is then inserted through the cap member 238 and into the locking cylinder 204 until the distal end area 208 becomes irreversibly locked against withdrawal from the inner cylinder bore as described above.

When the bolt body 202 is irreversibly locked in the locking cylinder 204, the position of the bolt body casing 216 relative to the cap member 238 is such that the locking finger 218 will become lodged in the locking abutment 242 and the key elements 220 are situated in the keyways 244. In addition, the first portion 262 of the bolt body casing 216 closes or seals the axial opening of the cap member 238 to prevent tampering with the locking finger 218. The fully assembled and locked lock bolt assembly 200 is shown in FIG. 10.

The lock bolt assembly according to the present disclosure accordingly provides a doubly secure seal with visible indications of a fully locked condition and visible evidence of any tampering of the lock bolt assembly causing or attempting to cause the bolt body to be separated from the locking cylinder.

The description and illustration herein of an exemplary lock bolt embodying the disclosure is not intended to limit the scope of the disclosure to the specific structure described and shown, but rather is intended to describe an example of the disclosure which is encompassed by the claims appended hereto. For instance, while a specific type of a first bolt body locking feature in the form of the split locking ring that cooperates with a circumferential locking groove of the bolt body is described, any suitable form of irreversible locking arrangement that meets any applicable specification for such a lock bolt assembly could be used as a first locking feature.

Likewise, while a locking finger arrangement is used as a second locking feature associated with the lock bolt assembly, any suitable irreversible locking arrangement could be used for the second locking feature that would serve the purpose of both indicating engagement of the first locking feature and integrity of the second locking feature to secure the bolt body against separation from the locking cylinder independently of and in addition to the first locking feature.

While the transparent cap member is illustrated and described as a separate member molded onto the locking cylinder over-molded casing, it is contemplated that the cap member could be integrated with the casing as a single piece or otherwise permanently joined to the casing as a separate member. Moreover, while the locking finger is described as being integrated with the bold body casing, it could be separately formed and permanently connected to or integrated with the bolt body. In yet other embodiments, the lock bolt assembly can include two key elements, four key elements, or any other suitable number of key elements and respective cooperating keyways. In other embodiments, the lower area or second portion of the bolt body may include a ribbed configuration or any other suitable configuration.

1. A lock bolt assembly comprising:
a bolt body extending axially along a length, the bolt body comprising metal and having a proximal end area, a distal end area, and a circumferential locking groove defined in the distal end area;
a locking cylinder comprising metal having an inner cylinder bore that has an open end and a cylinder locking feature, the locking groove and the cylinder locking feature are arranged to be irreversibly coupled to each other when the bolt body is fully received in the inner cylinder bore;
a transparent cap member connected to the locking cylinder and having an axial bore that is separate from the inner cylinder bore, the cap member defining a locking abutment in the axial bore and at least one keyway substantially vertically aligned with the locking abutment; and
a bolt body casing permanently attached to the bolt body and covering at least a portion of the proximal end area of the bolt body, the bolt body casing defines at least one key element and a locking finger located between the at least one key element and the locking groove of the bolt body, the at least one key element situated in the keyway and the locking finger engaging the locking abutment in an irreversible manner when the locking groove is irreversibly coupled to the cylinder locking feature.

2. The lock bolt assembly of claim 1, wherein the bolt body casing has an outer diameter substantially corresponding to a diameter of the axial bore such that when the bolt body is inserted into the locking cylinder the bolt body casing seals or closes the axial bore to thereby prevent tampering with the locking finger.

3. The lock bolt assembly of claim 2, wherein the outer diameter of the bolt body casing is substantially constant.

4. The lock bolt assembly of claim 1, wherein the at least one key element of the bolt body casing situated with the at least one keyway of the cap member prevents rotation of the bolt body relative to the locking cylinder when the bolt body is fully inserted into the locking cylinder.

5. The lock bolt assembly of claim 1, wherein the at least one key element has a lower portion having an upright configuration and an upper portion having a horizontal configuration extending radially outward beyond the lower portion.

6. The lock bolt assembly of claim 5, wherein the lower portion and the upper portion have substantially flat sides that are substantially parallel to one another.

7. The lock bolt assembly of claim 5, wherein the at least one keyway defines parallel sidewalls separated by a stop surface arranged to cooperate with a bottom surface of the upper portion of the at least one key element when the bolt body is fully inserted into the locking cylinder.

8. The lock bolt assembly of claim 5, wherein the axial bore defines a passageway arranged to allow the locking finger to pass through the at least one keyway and into engagement with the locking abutment when the bolt body is inserted into the locking cylinder.

9. The lock bolt assembly of claim 8, wherein the lower portion of the at least one key element is situated in the passageway when the bolt body is fully inserted into the locking cylinder.

10. The lock bolt assembly of claim 1, wherein the at least one key element comprises a rectangular portion.

11. The lock bolt assembly of claim 1, wherein the cylinder locking feature comprises an elastically expandable splint ring located within the cylinder bore.

12. The lock bolt assembly of claim 1, wherein the locking finger comprises a radially elastically bendable locking finger arranged to pass through the at least one keyway in a one-way manner during movement of the bolt body into the inner cylinder bore and to cooperate with the locking abutment upon complete passage of the locking finger through the keyway.

13. The lock bolt assembly of claim 1, further comprising a locking cylinder resin or plastic over-molded casing permanently attached to the locking cylinder.

14. The lock bolt assembly of claim 1, wherein the at least one key element comprises a plurality of key elements, and the at least one keyway comprises a corresponding plurality of keyways.

15. The lock bolt assembly of claim 14, wherein the plurality of keyways include a pair of keyways having an elongate configuration and spaced about 90 degrees from one another in the axial bore.

16. A lock bolt assembly comprising:
a bolt body extending axially along a length, the bolt body comprising metal and having a proximal end area, a distal end area, and a circumferential locking groove defined in the distal end area;
a locking cylinder comprising metal having an inner cylinder bore that has an open end and a cylinder locking feature, the locking groove and the cylinder locking feature arranged to be irreversibly coupled to each other when the bolt body is fully received in the inner cylinder bore;
a transparent cap member connected to the locking cylinder and having an axial bore that is separate from and axially spaced from the inner cylinder bore, the cap member defining a locking abutment in the axial bore and at least one keyway aligned with the locking abutment; and
an over-molded resin or plastic bolt body casing permanently attached to the bolt body and covering at least a portion of the proximal end area of the bolt body, the bolt body casing defines at least one key element and a locking finger located between the at least one key element and the locking groove of the bolt body, the at least one key element situated in the keyway and the locking finger engaging the locking abutment in an irreversible manner when the locking groove is irreversibly coupled to the cylinder locking feature,
wherein the bolt body casing has an outer diameter substantially corresponding to a diameter of the axial bore such that when the bolt body is inserted into the locking cylinder the bolt body casing seals or closes the axial bore to thereby prevent tampering with the locking finger.

17. The lock bolt assembly of claim 16, wherein the diameter of the axial bore is substantially constant.

18. The lock bolt assembly of claim 16, wherein the at least one key element comprises a plurality of key elements.

19. The lock bolt assembly of claim 16, wherein the bolt body casing is formed of hard resin material.

20. A lock bolt assembly comprising:
a bolt body extending axially along a length, the bolt body comprising metal and having a proximal end area, a distal end area, and a circumferential locking groove defined in the distal end area;
a locking cylinder having an inner cylinder bore that has an open end and a locking ring having a split configuration, the locking groove and the locking ring are arranged to be irreversibly coupled to each other when the bolt body is fully received in the inner cylinder bore;
a transparent cap member connected to the locking cylinder and having an axial bore that is separate from the inner cylinder bore, the cap member defining a locking abutment in the axial bore and at least one keyway substantially vertically aligned with the locking abutment; and
a bolt body casing permanently attached to the bolt body and covering at least a portion of the proximal end area of the bolt body, the bolt body casing defines at least one key defining a stop surface and a cantilevered locking finger located between the at least one key and the locking groove of the bolt body, the at least one key situated in the keyway and the locking finger engaging the locking abutment in an irreversible manner when the locking groove is irreversibly coupled to the locking ring.
